(19) United States
(12) Patent Application Publication
(10) Pub. No.: US 2020/0054144 A1
(43) Pub. Date: Feb. 20, 2020

(54) MODULAR ELECTRIC BEDSTEAD

(71) Applicant: Chuan-Hang Shih, Lukang Township (TW)

(72) Inventor: Chuan-Hang Shih, Lukang Township (TW)

(21) Appl. No.: 16/128,805

(22) Filed: Sep. 12, 2018

(30) Foreign Application Priority Data
Aug. 14, 2018 (TW) 107211106

(51) Int. Cl. A47C 19/00; A47C 1/024; A47C 19/04; A47C 20/04; A47C 20/10; F15B 15/14

(52) U.S. Cl. CPC A47C 19/005; A47C 1/024; A47C 19/04; F15B 15/1457; A47C 20/10; F15B 15/1414; A47C 20/041

(57) ABSTRACT

A modular electric bedstead includes an upper body supporting unit having a front base, a back supporting rack pivotally connected with the front base, and a front actuator pivotally connected between the front base and the back supporting rack, a lower body supporting unit having a rear base, a thigh supporting rack pivotally connected with the rear base, a lower leg supporting rack pivotally connected with the thigh supporting rack, and a rear actuator pivotally connected between the rear base and the thigh supporting rack, and a buttock supporting unit having two middle bases and a buttock supporting rack detachably and across disposed on the two middle bases. Each middle base has front and rear ends detachably connected with the front and rear bases, respectively. The bedstead is dismantlable to reduce the space occupied and can be flatly packed for facilitating transportation.

### BACKGROUND OF THE INVENTION

### 1. Field of the Invention

The present invention relates generally to an electric bedstead and more particularly, to a modular electric bedstead composed of detachable functional units.

### 2. Description of the Related Art

Conventional electric bedsteads generally have considerable volume and weight as well as a relatively longer length. As a result, the conventional electric bedsteads will occupy a big volume of space during transportation and storage, which is not cost-effective. Further, when consumers purchase conventional electric bedsteads, because of size and weight, they might not be able to carry the purchased electric bedstead by themselves but have to engage a shipping service, resulting in increase of the purchase cost. Therefore, a technical issue of reducing volume of the electric bedstead so as to lower the transportation cost and/or to allow consumers to carry and transport the electric bedstead needs to be solved by manufacturers and practitioners in this industry field.

### SUMMARY OF THE INVENTION

The present invention has been accomplished in view of the above-noted circumstances. It is an objective of the present invention to provide a modular electric bedstead, which can be flatly packed before it is assembled or after it is dismantled, facilitating transportation of the modular electric bedstead by a user himself/herself Another objective of the present invention is to provide a modular electric bedstead, which can be conveniently and simply assembled by a user himself/herself without a need of professional skill. Still another objective of the present invention is to provide a modular electric bedstead, which has a stable structure after it is assembled.

To attain the above objectives, the present invention provides a modular electric bedstead comprising an upper body supporting unit, a lower body supporting unit and a buttock supporting unit. The upper body supporting unit includes a front base, a back supporting rack pivotally connected with the front base, and a front actuator having two ends pivotally and respectively connected with the front base and the back supporting rack for driving the back supporting rack to swing between a horizontal position and an inclined position. The lower body supporting unit includes a rear base, a thigh supporting rack pivotally connected with the rear base, a lower leg supporting rack pivotally connected with the thigh supporting rack, and a rear actuator having two ends pivotally and respectively connected with the rear base and the thigh supporting rack for driving the thigh supporting rack to swing between a horizontal position and an inclined position. The buttock supporting unit includes two middle bases, and a buttock supporting rack detachably and across disposed on the two middle bases. Each middle base has a front end detachably connected with the front base, and a rear end detachably connected with the rear base. As a result, the modular electric bedstead is dismantlable to reduce the space occupied so as to lower the transportation cost, and the modular electric bedstead can be packed in a flat manner for facilitating transportation thereof. Further, the modular electric bedstead has a stable structure after it is assembled, and a simple structure that can be conveniently assembled by a user himself/herself.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a modular electric bedstead according to an embodiment of the present invention;

FIG. 2 is a lateral side view of the modular electric bedstead, showing a back supporting rack and a thigh supporting rack in inclined positions;

FIG. 3 is another lateral view of the modular electric bedstead, showing the back supporting rack and the thigh supporting rack in horizontal positions;

FIG. 4 is an exploded view of the modular electric bedstead according to the embodiment of the present invention; and

FIGS. 5 and 6 are perspective and lateral side views showing the modular electric bedstead is dismantled in a state of being packaged.

### DETAILED DESCRIPTION OF THE INVENTION

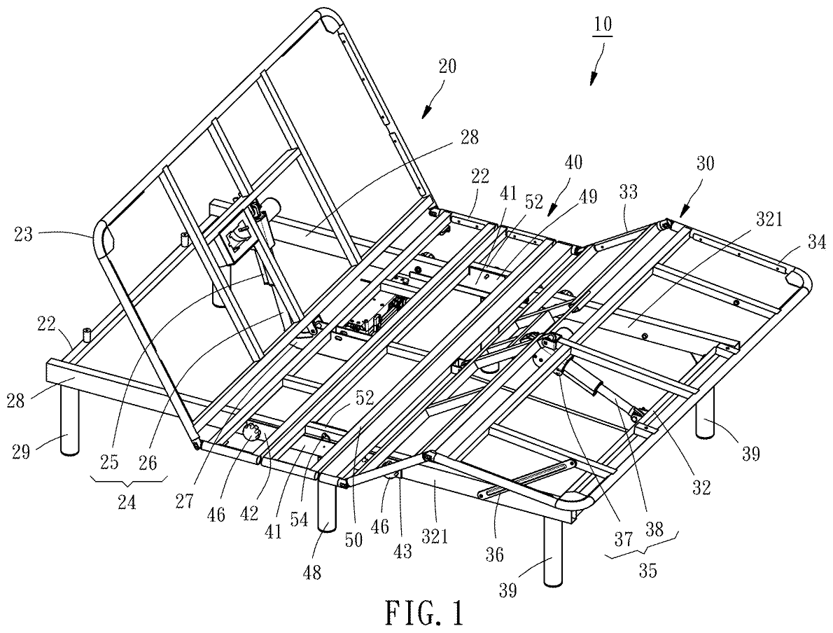

The structure and technical features of the present invention will be detailedly described hereunder by an embodiment and accompany drawings. As shown in FIG. 1, a modular electric bedstead 10 provided in accordance with an embodiment of the present invention is composed of an upper body supporting unit 20, a lower body supporting unit 30 and a buttock supporting unit 40.

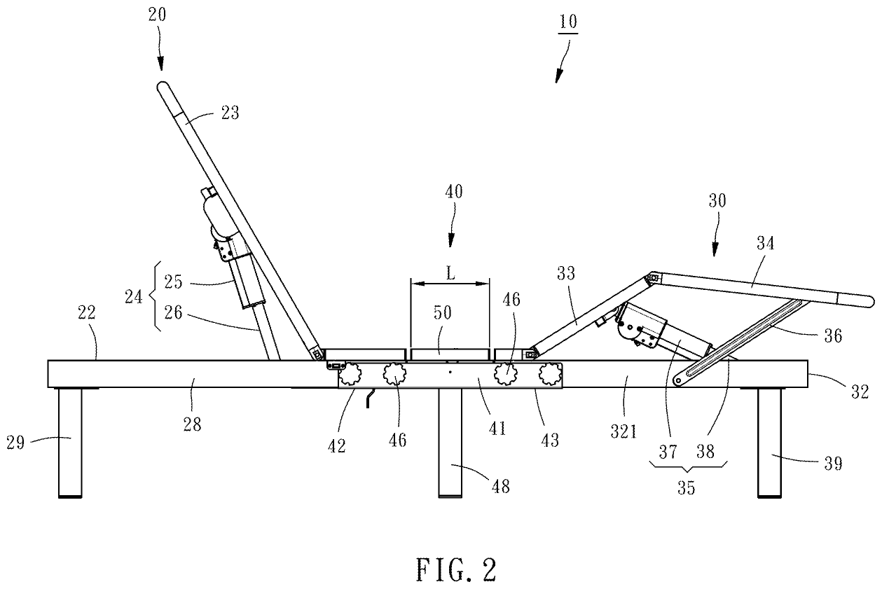

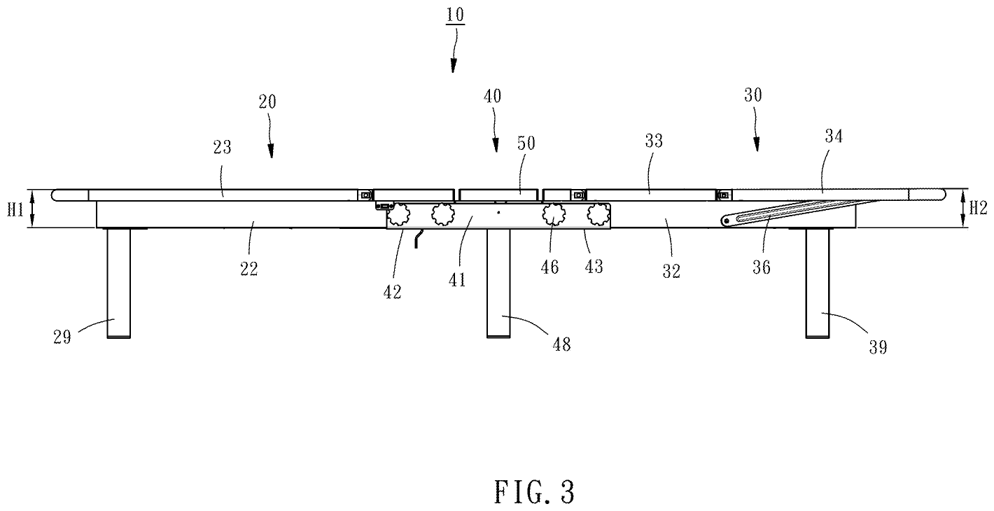

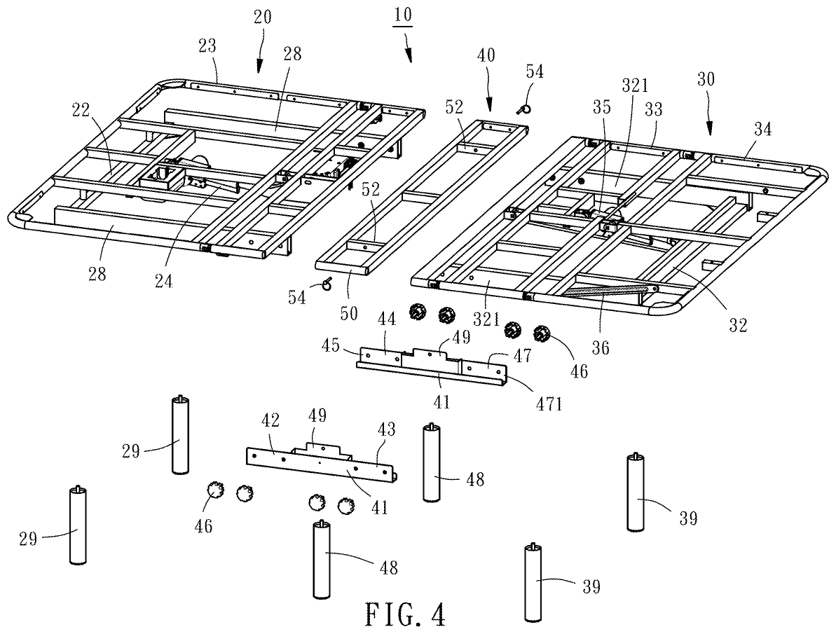

The upper body supporting unit 20 includes a front base 22, a back supporting rack 23 provided with a rear side pivotally connected with the front base 22, and a front actuator 24 having two ends pivotally connected with the front base 22 and the back supporting rack 23, respectively. The front actuator 24 is capable of driving the back supporting rack 23 to swing between a horizontal position as shown in FIG. 3 and an inclined position as shown in FIG. 1. It is to be noted that the so-called front direction mentioned in the present invention is directed to the left direction of FIG. 1, and the so-called rear direction is directed to the right direction of FIG. 1. As shown in FIGS. 1 and 2, the front actuator 24 is composed of a front cylinder body 25 and a front slidable rod 26 that can backwardly protrude out of and forwardly retract into the front cylinder body 25. The front cylinder body 25 has a front end pivotally connected to a middle portion of the back supporting rack 23, and the front slidable rod 26 has a rear end pivotally connected to a front connecting portion 27 of the front base 22. With this structural feature, the thickness of the upper body supporting unit 20 can be configured as thinner as possible. That is, when the front slidable rod 26 retracts into the front cylinder body 25 to drive the back supporting rack 23 to the horizontal position, the upper body supporting unit 20 will have a minimum height, namely a first height H1. Further, at each of the left and right lateral sides of the front base 22, a first longitudinal rod 28 is provided. Each of the first longitudinal rods 28 extends in the front and rear direction and has a front portion optionally equipped with a support leg 29 so as to raise the height of the modular electric bedstead 10.

The lower body supporting unit 30 includes a rear base 32, a thigh supporting rack 33 provided with a front side pivotally connected with the rear base 32, a lower leg supporting rack 34 having a front side pivotally connected with a rear side of the thigh supporting rack 33, a rear actuator 35 having two ends pivotally connected with the rear base 32 and the thigh supporting rack 33, respectively, and a link 36 having two ends pivotally connected with the rear base 32 and the lower leg supporting rack 34. The rear actuator 35 is capable of driving the thigh supporting rack 33 to swing between a horizontal position as shown in FIG. 3 and an inclined position as shown in FIG. 1. During the process of swinging the thigh supporting rack 33 from the horizontal position to the inclined position, the lower leg supporting rack 34 will also swing from a horizontal position as shown in FIG. 3 to a lifted position as shown in FIG. 1. As shown in FIGS. 1 and 2, the rear actuator 35 is composed of a rear cylinder body 37 and a rear slidable rod 38 that can backwardly protrude out of and forwardly retract into the rear cylinder body 37. The rear cylinder body 37 has a front end pivotally connected to a middle portion of the thigh supporting rack 33, and the rear slidable rod 38 has a rear end pivotally connected to the rear base 32. With this structural feature, the thickness of the lower body supporting unit 30 can be configured as thinner as possible. That is, when the rear slidable rod 38 retracts into the rear cylinder body 37 to drive the thigh supporting rack 33 and the lower leg supporting rack 34 to the horizontal positions thereof, the lower body supporting unit 30 will have a minimum height, namely a second height H2. Further, at each of the left and right lateral sides of the rear base 32, a third longitudinal rod 321 is provided. Each of the third longitudinal rods 321 extends in the front and rear direction and has a rear portion optionally equipped with a support leg 39 so as to raise the height of the modular electric bedstead 10.

The buttock supporting unit 40 includes two middle bases 41, and a buttock supporting rack 50 detachably and transversely disposed on the two middle bases 41. Each middle base 41 has a front end 42 detachably connected with the front base 22, and a rear end 43 detachably connected with the rear base 32. The connecting ways among the middle bases 41, the front base 22 and the rear base 32 may vary and have many modifications. In this embodiment of the present invention, each middle base 41 is provided with a front groove 44 that receives one of the two first longitudinal rods 28. Specifically, the front groove 44 of each of the two middle bases 41 has a top and front opening 45, such that each first longitudinal rod 28 can extend into one of the front grooves 44 through the top and front opening 45. By means of transversely inserting four connecting members 46 through the two middle bases 41 and associated two first longitudinal rods 28, the front base 22 is connected with the two middle bases 41. In addition, each middle base 41 is further provided with a rear groove 47 that receives one of the two third longitudinal rods 321. Specifically, the rear groove 47 of each middle base 41 has a top and rear opening 471, such that each third longitudinal rod 321 can extend into one of the rear grooves 47 through the top and rear opening 471. By means of transversely inserting another four connecting members 46 through the two middle bases 41 and associated two third longitudinal rods 321, the rear base 32 is connected with the two middle bases 41. In this embodiment, the connecting members 46 are realized as screws; however, in other embodiments, the connecting members 46 may be realized as pins or other members having connecting function. The amount of the connecting members 46 may vary, and the connecting members 46 may be horizontally arranged or vertically arranged. Further, each middle base 41 may be optionally equipped with a support leg 48 so as to raise the height of the modular electric bedstead 10.

The buttock supporting rack 50 has a longitudinal length L, i.e. the length extending in the front and rear direction as shown in FIG. 2. The longitudinal length L is approximately equal to a sum of the first height H1 of the upper body supporting unit 20 and the second height H2 of the lower body supporting unit 30. The buttock supporting rack 50 includes two second longitudinal rods 52 extending in the front and rear direction. Each middle base 41 includes a vertically extending limiting wall 49 between the front groove 44 and the rear groove 47 and located by one of the two second longitudinal rods 52. The buttock supporting rack 50 and the two middle bases 41 are connected by two pins 54 in a way that each pin 54 penetrates through the limiting wall 49 of one of the two middle bases 41 and associated one of the two second longitudinal rods 52. By means of pulling off the two pins 54, the buttock supporting rack 50 can be separated from the two middle bases 41. The way of dismantling and assembling the buttock supporting rack 50 and the middle bases 41 can be conveniently operated thanks to the pins 54. In this embodiment, each second longitudinal rod 52 has an inner side and an outer side opposite to the inner side, and the two second longitudinal rods 52 are arranged in a way that the inner sides face to each other and the two limiting walls 49 of the two middle bases 41 are located by the inner sides, respectively. However, in other embodiments, the two second longitudinal rods 52 may be arranged in a way that the two limiting walls 49 of the two middle bases 41 are located by the outer sides of the two second longitudinal rods 52, respectively.

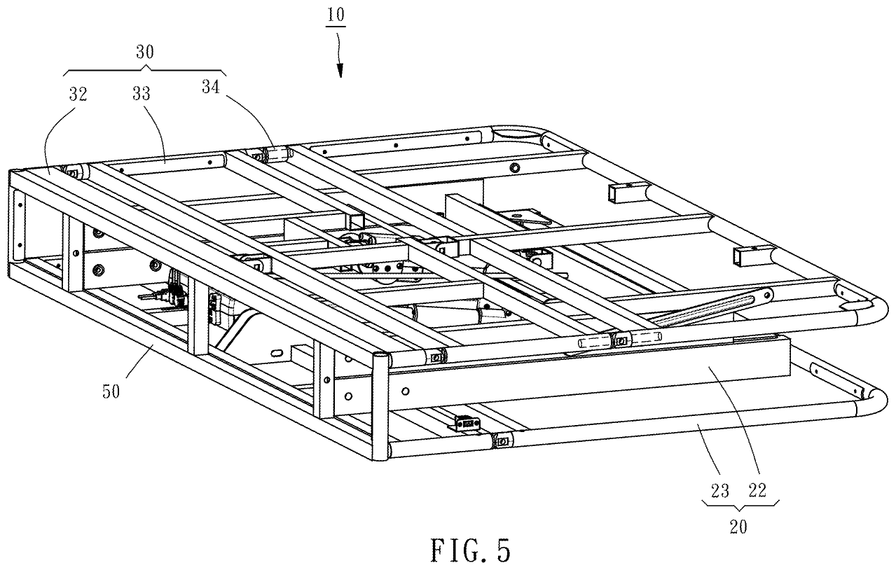

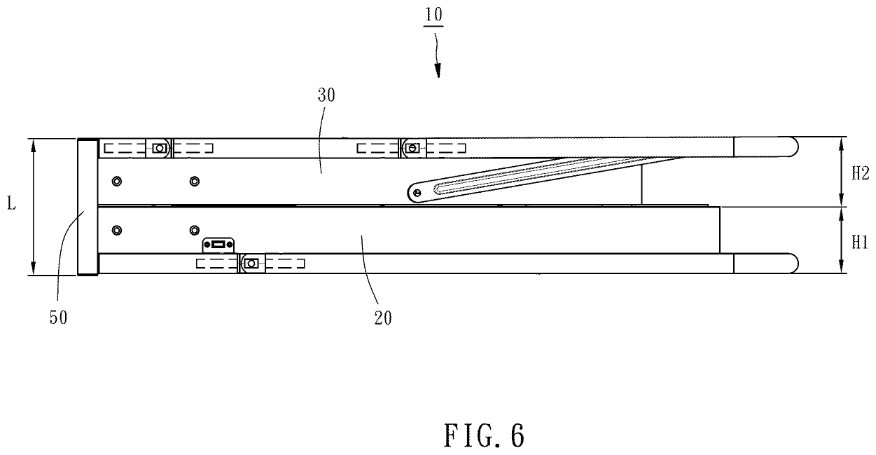

With the above-described structural design, the upper body supporting unit 20, the lower body supporting unit 30 and the buttock supporting unit 40 can be stably assembled together, and the upper body supporting unit 20, the lower body supporting unit 30 and the buttock supporting unit 40 can be conveniently dismantled from each other by means of detaching the connecting members 46. Further, by means of detaching the pins 54, the buttock supporting rack 50 can be conveniently dismantled from the two middle bases 41. Furthermore, the support legs 29, 39 and 48 are respectively mounted to the front base 22, the rear base 32 and the middle bases 41 by screws, such that these support legs 29, 39 and 48 can be conveniently and respectively dismantled from the front base 22, the rear base 32 and the middle bases 41 by means of turning and loosening these support legs 29, 39 and 48. Moreover, as shown in FIGS. 5 and 6, the upper body supporting unit 20 and the lower body supporting unit 30 can be stacked together first, and then the buttock supporting rack 50 can be vertically arranged by a side of the stack of the upper and lower body supporting units 20 and 30, and thereafter the other members having relatively smaller sizes can be placed in between the upper body supporting unit 20 and the lower body supporting unit 30. In this way, the modular electric bedstead 10 can be flatly packed with relatively smaller volume so as to reduce transportation cost and facilitate carry and transportation thereof. In another aspect, the modular electric bedstead 10 has a simple structure that can be conveniently assembled by a user himself/herself, minimizing the transportation and installation cost. As a result, the modular electric bedstead 10 of the present invention may have a great potential in trade market.

Based on the technical features of the present invention, various modifications to the structure of the modular electric bedstead 10 of the present invention may be made. For example, the front groove 44 and the rear groove 47 of the middle base 41 may be configured as being communicated with each other. The front groove 44 may be configured having a front opening, not a top and front opening 45 as depicted in the above-mentioned embodiment, as long as the first longitudinal rod 28 can extend into the front groove 44. Similarly, the rear groove 47 may be configured having a rear opening, not a top and rear opening 471 as depicted in the above-mentioned embodiment, as long as the third longitudinal rod 321 can extend into the rear groove 47.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A modular electric bedstead, comprising:
an upper body supporting unit, which comprises a front base, a back supporting rack pivotally connected with the front base, and a front actuator having two ends pivotally and respectively connected with the front base and the back supporting rack for driving the back supporting rack to swing between a horizontal position and an inclined position;
a lower body supporting unit, which comprises a rear base, a thigh supporting rack pivotally connected with the rear base, a lower leg supporting rack pivotally connected with the thigh supporting rack, and a rear actuator having two ends pivotally and respectively connected with the rear base and the thigh supporting rack for driving the thigh supporting rack to swing between a horizontal position and an inclined position; and
a buttock supporting unit comprising two middle bases, and a buttock supporting rack detachably and across disposed on the two middle bases, each of the two middle bases having a front end detachably connected with the front base, and a rear end detachably connected with the rear base.

2. The modular electric bedstead as claimed in claim 1, wherein the upper body supporting unit has a first height when the back supporting rack stays at the horizontal position; the lower body supporting unit has a second height when the thigh supporting rack stays at the horizontal position; the buttock supporting rack has a longitudinal length which is substantially equal to a sum of the first height and the second height.

3. The modular electric bedstead as claimed in claim 1 wherein the front base comprises two first longitudinal rods; each of the two middle bases is provided with a front groove, in which one of the two first longitudinal rods is received.

4. The modular electric bedstead as claimed in claim 3, further comprising two connecting members; the front base is connected with the two middle bases by the two connecting members in a way that each of the two connecting members transversely penetrates through one of the two middle bases and associated one of the two first longitudinal rods.

5. The modular electric bedstead as claimed in claim 3, wherein the front groove of each of the two middle bases has a top and front opening, into which one of the two first longitudinal rods extends.

6. The modular electric bedstead as claimed in claim 1, wherein the buttock supporting rack comprises two second longitudinal rods; each of the two middle bases comprises a limiting wall located by one of the two second longitudinal rods; the buttock supporting rack and the two middle bases are connected by two pins in a way that each of the two pins penetrates through the limiting wall of one of the two middle bases and associated one of the two second longitudinal rods.

7. The modular electric bedstead as claimed in claim 6, wherein each of the two second longitudinal rods has an inner side and an outer side opposite to the inner side; the inner sides of the two second longitudinal rods face to each other; the two limiting walls of the two middle bases are located by the inner sides or the outer sides of the two longitudinal rods, respectively.

8. The modular electric bedstead as claimed in claim 1, wherein the rear base comprises two third longitudinal rods; each of the two middle bases is provided with a rear groove, in which one of the two third longitudinal rods is received.

9. The modular electric bedstead as claimed in claim 8, further comprising two connecting members; the rear base is connected with the two middle bases by the two connecting members in a way that each of the two connecting members transversely penetrates through one of the two middle bases and associated one of the two third first longitudinal rods.

10. The modular electric bedstead as claimed in claim 8, wherein the rear groove of each of the two middle bases has a top and rear opening, into which one of the two third longitudinal rods extends.

11. The modular electric bedstead as claimed in claim 1, wherein the front base has two lateral sides each disposed with a support leg; each of the two middle bases is disposed with a support leg; the rear base has two lateral sides each disposed with a support leg.

12. The modular electric bedstead as claimed in claim 1, wherein the lower body supporting unit comprises a link having two ends pivotally connected with the rear base and the lower leg supporting rack, respectively.
